(19) United States
(12) Patent Application Publication
(10) Pub. No.: US 2025/0087669 A1
(43) Pub. Date: Mar. 13, 2025

(54) NEGATIVE ELECTRODE FOR BATTERY, BATTERY, AND METHOD FOR MANUFACTURING NEGATIVE ELECTRODE FOR BATTERY

(71) Applicant: TOYOTA JIDOSHA KABUSHIKI KAISHA, Toyota-shi (JP)

(72) Inventor: Shinsuke MATSUHARA, Miyoshi-shi (JP)

(73) Assignee: TOYOTA JIDOSHA KABUSHIKI KAISHA, Toyota-shi (JP)

(21) Appl. No.: 18/659,032

(22) Filed: May 9, 2024

(30) Foreign Application Priority Data
Sep. 13, 2023 (JP) 2023-148776

(51) Int. Cl. H01M 4/36; H01M 4/02; H01M 4/133; H01M 4/134; H01M 4/38; H01M 4/587; H01M 4/62

(52) U.S. Cl. CPC H01M 4/364; H01M 4/133; H01M 4/134; H01M 4/386; H01M 4/587; H01M 4/62; H01M 2004/027

(57) ABSTRACT

A negative electrode for a battery includes a negative electrode active material layer. When a cross-sectional image of the negative electrode active material layer is observed, the negative electrode active material layer contains one silicon-based particle Ps. In the cross-sectional image, a ratio B/A is 1.05 or more and 3.10 or less, where A is an average area of the silicon-based particle Ps, and B is an average area of an ellipse or a perfect circle that is drawn in a region where the silicon-based particle Ps is separated from the carbon-based particles Pc, and a ratio D/C is 1.5 or more and 2.8 or less, where C is an average particle size of the silicon-based particle Ps, and D is an average particle size of the carbon-based particles Pc.

### CROSS-REFERENCE TO RELATED APPLICATION

This application claims priority to Japanese Patent Application No. 2023-148776 filed on Sep. 13, 2023, incorporated herein by reference in its entirety.

### BACKGROUND

### 1. Technical Field

The present disclosure relates to negative electrodes for batteries, batteries, and methods for manufacturing a negative electrode for a battery.

### 2. Description of Related Art

Conventionally, attempts have been made to use a negative electrode active material layer containing silicon-based particles such as silicon particles in a negative electrode for a battery.

For example, Japanese Unexamined Patent Application Publication No. 2012-84522 (JP 2012-84522 A) discloses a negative electrode for a lithium-ion secondary battery. A current collector of this negative electrode has porous silicon particles on at least one surface thereof. The porous silicon particles have an average particle size of 0.1 μm to 50 μm, have a three-dimensional network structure, have an average porosity of 20% to 90%, and have an average pore size of 5 nm to 2 μm. The ratio of the average particle size to the average pore size of the porous silicon particles is 5 or more, and the porous silicon particles, excluding oxygen, contains 80 atomic % or more of silicon.

Japanese Unexamined Patent Application Publication No. 2017-054660 (JP 2017-054660 A) discloses a lithium-ion secondary battery whose negative electrode is coated with a negative electrode mixture. The negative electrode mixture contains, as a negative electrode active material, graphite and a silicon (Si)-based negative electrode active material. The proportion of the Si-based negative electrode active material to the total of the graphite and the Si-based negative electrode active material is in the range of 2 wt % to 17 wt %. The porosity of the negative electrode mixture is in the range of 30% to 60%. The ratio of the thickness of the negative electrode mixture layer to the D50 particle size of the negative electrode active material (thickness/D50) is 3 to 10. The thickness of the negative electrode mixture layer is 30 μm or less. The particle size ratio of the Si-based negative electrode active material to the graphite (D50 of the Si-based negative electrode active material to D50 of the graphite) is in the range of 0.6 to 1.2.

Japanese Unexamined Patent Application Publication No. 2015-219989 (JP 2015-219989 A) discloses a negative electrode active material for a lithium-ion secondary battery. This negative electrode active material is prepared by adding a carbonized material to a composite material having an average particle size of 1 μm to 40 μm. The composite material is composed of Si or Si alloy having an average particle size of 0.01 μm to 5 μm and either a carbonaceous material or a carbonaceous material and graphite.

Japanese Unexamined Patent Application Publication No. 2013-101921 (JP 2013-101921 A) discloses a negative electrode for a lithium-ion secondary battery. This negative electrode includes a current collector and an active material layer formed on a surface of the current collector. The active material layer contains an active material, a binder, and a buffer material. The active material is composed of SiOₓ powder (0.5≤x≤1.5), and the buffer material is composed of graphite powder. The Dso of the SiOₓ powder is ¼ to ½ of the D50 of the graphite powder. The content of the graphite powder is 36 mass % to 61 mass % per 100 mass % of the total mass of the graphite powder and the SiOₓ powder, and the content of the binder is 5 mass % to 25 mass % per 100 mass % of the total mass of the active material layer.

### SUMMARY

In a negative electrode active material layer containing both silicon-based particles and carbon-based particles, the silicon-based particles may undergo volume expansion during charging and discharging of a battery. This volume expansion may cause pulverization and separation of the negative electrode active material, cracking of the negative electrode active material layer, and a decrease in electrically conductive properties in the negative electrode active material, etc., which may result in a decrease in battery capacity. Accordingly, there is a demand for a negative electrode for a battery that reduces a decrease in battery capacity even if silicon-based particles undergo volume expansion during charging and discharging of the battery.

The present disclosure was made in view of the above circumstances, and it is an object of the present disclosure to provide a negative electrode for a battery and battery that reduce a decrease in battery capacity, and a method for manufacturing the negative electrode.

Means for addressing the above issue includes the following aspects. A negative electrode for a battery according to one aspect of the present disclosure includes a negative electrode active material layer containing silicon-based particles and carbon-based particles. When a cross-sectional image of the negative electrode active material layer is observed, the negative electrode active material layer contains one silicon-based particle Ps surrounded by a plurality of carbon-based particles Pc and separated from the carbon-based particles Pc. In the cross-sectional image, a ratio B/A is 1.05 or more and 3.10 or less, where A is an average area of the silicon-based particle Ps, and B is an average area of an ellipse or a perfect circle that is drawn in a region where the silicon-based particle Ps is separated from the carbon-based particles Pc, the ellipse or the perfect circle having a maximum area, containing the silicon-based particle Ps, and not overlapping contours of the carbon-based particles Pc, and a ratio D/C is 1.5 or more and 2.8 or less, where C is an average particle size of the silicon-based particle Ps, and D is an average particle size of the carbon-based particles Pc.

In the negative electrode of the above aspect, the ratio B/A may be 1.30 or more and 2.40 or less.

In the negative electrode of the above aspect, a water-insoluble cellulose compound may be contained in the region where the silicon-based particle Ps is separated from the carbon-based particles Pc.

A battery according to another aspect of the present disclosure includes the negative electrode of the above aspect.

A method for manufacturing a negative electrode for a battery according to still another aspect of the present disclosure includes the steps of: causing a water-insoluble cellulose compound to adhere to surfaces of silicon-based particles; and forming a negative electrode active material layer by mixing the silicon-based particles with the water-insoluble cellulose compound adhering to the surfaces and carbon-based particles.

The present disclosure provides a negative electrode for a battery and battery that reduce a decrease in battery capacity, and a method for manufacturing the negative electrode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view showing part of a cross-sectional image of a negative electrode active material layer included in a negative electrode for a battery according to an embodiment of the present disclosure; and

FIG. 2 is a schematic cross-sectional view showing part of a cross-sectional image, illustrating one step of a method for manufacturing a negative electrode for a battery according to the embodiment of the present disclosure.

### DETAILED DESCRIPTION OF EMBODIMENTS

Hereinafter, an embodiment that is an example of the present disclosure will be described. These descriptions and examples are illustrative of the embodiment and are not intended to limit the scope of the disclosure.

In the numerical ranges described in the present specification in a stepwise manner, the upper limit value or the lower limit value described in one numerical range may be replaced with the upper limit value or the lower limit value of the numerical range described in another stepwise manner. In addition, in the numerical range described in the present specification, the upper limit value or the lower limit value of the numerical range may be replaced with the value shown in the examples.

Each component may contain a plurality of corresponding substances. When referring to the amount of each component in a composition, when a plurality of substances corresponding to each component are present in the composition, unless otherwise specified, it means the total amount of the plurality of substances present in the composition.

### Negative Electrode for Battery

A negative electrode for a battery according to an embodiment of the present disclosure includes a negative electrode active material layer including silicon-based particles and carbon-based particles. The negative electrode active material layers have one silicon-based particle Ps surrounded by a plurality of carbon-based particles Pc and separated from the carbon-based particles Pc when the cross-sectional image is observed. In the cross-sectional image, the ratio B/A is 1.05 or more and 3.10 or less, where A is an average area of the silicon-based particle Ps, and B is an average area of an ellipse or a perfect circle that is drawn in a region where the silicon-based particle Ps is separated from the carbon-based particles Pc, the ellipse or the perfect circle having a maximum area, containing the silicon-based particle Ps, and not overlapping contours of the carbon-based particles Pc.

The ratio D/C is 1.5 or more and 2.8 or less, where C is an average particle size of the silicon-based particle Ps, and D is an average particle size of the carbon-based particles Pc.

Silicon-based particles and carbon-based particles in the negative electrode active material layer included in the negative electrode for a battery according to the embodiment of the present disclosure will be described with reference to the drawings.

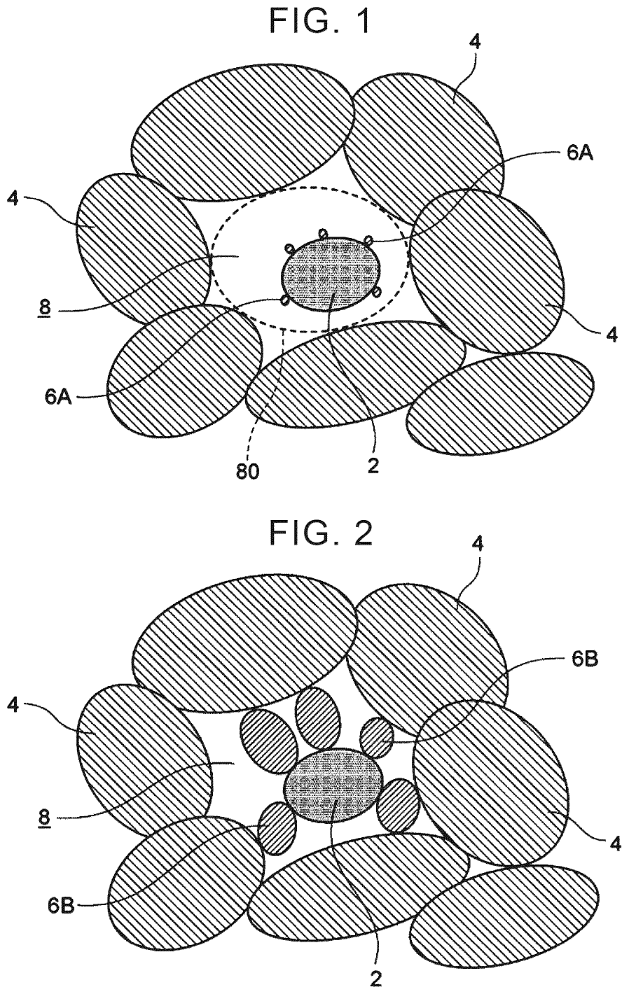

FIG. 1 is a schematic cross-sectional view showing part of a cross-sectional image of the negative electrode active material layers.

As shown in FIG. 1, the cross-sectional image of the negative electrode active material layers includes carbon-based particles (Pc) 4 and one silicon-based particle (Ps) 2 surrounded by a plurality of carbon-based particles (Pc) 4 and separated from these carbon-based particles (Pc) 4. There is a void 8 around the silicon-based particle (Ps) 2 because the silicon-based particle (Ps) 2 is separated from the plurality of carbon-based particles (Pc) 4 surrounding the silicon-based particle (Ps) 2.

In the cross-sectional image, the ratio B/A is 1.05 or more and 3.10 or less, where A is an average area of the silicon-based particle (Ps) 2, and B is an average area of an ellipse or perfect circle 80 that is drawn in a region where the silicon-based particle (Ps) 2 is separated from the carbon-based particles (Pc) 4 (i.e., a void 8), the ellipse or perfect circle 80 having a maximum area, containing the silicon-based particle (Ps) 2, and not overlapping the contours of the carbon-based particles (Pc) 4.

When a cross-sectional image of the negative electrode active material layer is observed, there may also be a carbon-based particle and a silicon-based particle that are not in a state in which “one silicon-based particle (Ps) is surrounded by a plurality of carbon-based particles (Pc) and separated from the carbon-based particle (Pc)” (hereinafter simply referred to as “specific state”). Examples of the carbon-based particles and the silicon-based particles that are not in a specific state include a state in which the silicon-based particles and the other silicon-based particles are adjacent to each other without passing through the carbon-based particles. When the average area B of the ellipse or perfect circle 80 is determined, the carbon-based particles (Pc) and the silicon-based particles (Ps) in a particular condition are targeted.

In the present disclosure, the carbon-based particles corresponding to a specific state are referred to as “carbon-based particle Pc” or “carbon-based particles (Pc)”, and the silicon-based particles corresponding to a specific state are referred to as “silicon-based particle Ps” or “silicon-based particles (Ps)”.

In the negative electrode active material layer of the negative electrode for a battery according to the embodiment of the present disclosure, the ratio D/C is 1.5 or more and 2.8 or less, where C is an average particle size of the silicon-based particle 2, and D is an average particle size of the carbon-based particles 4.

Particles of a water-insoluble cellulose compound 6A are present on the silicon-based particles 2 shown in FIG. 1.

In the negative electrode for a battery according to the embodiment of the present disclosure, a decrease in battery capacity is suppressed by satisfying the above-described configuration. The reason is inferred as follows.

In the negative electrode active material layer including both of the silicon-based particles and the carbon-based particles, due to the influence of the volume expansion of the silicon-based particles generated during charging and discharging of the battery, pulverization and peeling of the negative electrode active material, cracks in the negative electrode active material layer, deterioration in conductivity between the negative electrode active materials, and the like occur, and as a result, the battery capacity may be lowered.

In the case where voids are provided inside the silicon-based particles (for example, porous silicon-based particles are used), stress concentration in the interior of the silicon-based particles occurs during volume expansion, and deterioration of the active material is easily accelerated, and the effect of suppressing a decrease in battery capacity is not sufficiently exhibited.
Therefore, there is a demand for a negative electrode for a battery in which a decrease in battery capacity is suppressed even when volume expansion occurs in silicon-based particles during charging and discharging.

On the other hand, the negative electrode for a battery according to the embodiment of the present disclosure has one silicon-based particle (Ps) surrounded by a plurality of carbon-based particles (Pc) and separated from the carbon-based particles (Pc) when the cross-sectional image of the negative electrode active material layer is observed. In the cross-sectional image, the ratio B/A is 1.05 or more and 3.10 or less, where A is an average area of the silicon-based particle (Ps), and B is an average area of an ellipse or a perfect circle that is drawn in a region where the silicon-based particle (Ps) is separated from the carbon-based particles (Pc), the ellipse or perfect circle having a maximum area, containing the silicon-based particle (Ps), and not overlapping contours of the carbon-based particles (Pc). This ratio B/A being 1.05 or more and 3.10 or less means that the silicon-based particle (Ps) is appropriately separated from the plurality of carbon-based particles (Pc) surrounding the silicon-based particle (Ps). By providing a void between the silicon-based particle (Ps) and the carbon-based particles (Pc) surrounding the silicon-based particle (Ps) as described above, it is possible to provide a margin for volume expansion of the silicon-based particles generated during charge and discharge of the batteries. Therefore, even if a volume symptom occurs in the silicon-based particle (Ps), the effect on the carbon-based particles (Pc) surrounding the periphery thereof is suppressed, and the carbon-based particles (Pc) can be suppressed from being rearranged. As a result, occurrence of pulverization and peeling of the negative electrode active material, cracks in the negative electrode active material layer, deterioration in conductivity between the negative electrode active materials, and the like can be suppressed, and deterioration in battery capacity can be suppressed.

### Ratio B/A

In the negative electrode for a battery according to the embodiment of the present disclosure, the ratio B/A is 1.05 or more and 3.10 or less. Since the ratio B/A is 1.05 or more, the silicon-based particle (Ps) is appropriately separated from the plurality of carbon-based particles (Pc) surrounding the silicon-based particle (Ps), so that a decrease in battery capacity is reduced. Since the ratio B/A is 3.10 or less, the contacting between the silicon-based particles (Ps) and the carbon-based particles (Pc) can be stabilized.

The ratio B/A is preferably 1.10 or more and 2.80 or less, more preferably 1.30 or more and 2.40 or less.

### Measurement Method of Average Areas A and B

Here, methods of calculating the average area A of the silicon-based particle (Ps) and the average area B of the ellipse or perfect circle will be described.

First, a cross-sectional image of the negative electrode active material layer in a state after discharge is obtained. Specifically, when the object is a battery, the battery is disassembled after discharging to SOC0%, and a negative electrode is collected. Next, the negative electrode is subjected to CP (cross-sectional polisher) processing to prepare a cross-sectional sample, and SEM (scanning-electron-microscope) images of the cross-sectional sample are observed.
In SEM images of the negative electrode active material layers, the carbon-based particle and the silicon-based particles in a specific state (that is, the state in which one silicon-based particle (Ps) is surrounded by a plurality of carbon-based particles (Pc) and separated from the carbon-based particles (Pc)) are to be measured.

First, 10 silicon-based particles (Ps) with all cross-sections exposed are randomly selected, and the area of each cross-section is measured, and the arithmetic mean value of the areas is defined as the average area A (μm²) of the silicon-based particles (Ps).

In addition, an ellipse or perfect circle having a maximum area, containing the silicon-based particle (Ps), and not overlapping the contours of the carbon-based particle (Pc) is drawn in a region where the silicon-based particle (Ps) is separated from the carbon-based particle (Pc). For example, in the embodiment shown in FIG. 1, a silicon-based particle (Ps) 2 is surrounded by six carbon-based particles (Pc) 4, and an ellipse or perfect circle 80 having a maximum area, containing the silicon-based particle (Ps) 2, and not overlapping the contours of the six carbon-based particles (Pc) 4 is drawn in the region where the silicon-based particle (Ps) 2 is separated from the carbon-based particles (Pc) 4 (void 8). It should be noted that a circle having the maximum area may be drawn, and the shape of the circle may be an ellipse or a perfect circle. Then, the area of the ellipse or perfect circle is measured. The area of the ellipse or perfect circle is measured with respect to 10 carbon-based particles and silicon-based particles that are in a particular condition, and the arithmetic mean value of the areas is defined as the average area B (μm²).

### Ratio D/C

In the negative electrode for a battery according to the embodiment of the present disclosure, the ratio D/C is 1.5 or more and 2.8 or less. Since the ratio D/C is 1.5 or more, the silicon-based particles (Ps) and the plurality of carbon-based particles (Pc) surrounding the silicon-based particles (Ps) can be appropriately separated from each other, and a decrease in the cell capacity can be suppressed. Since the ratio D/C is 2.8 or less, the particle size of the silicon-based particles (Ps) and the carbon-based particles (Pc) is appropriately balanced, and thus the contacting between the particles can be stabilized.

The ratio D/C is preferably 1.6 or more and 2.4 or less, more preferably 1.7 or more and 2.0 or less.

### Method for Measuring Average Particle Sizes C, D

Here, methods for calculating the average particle size C of the silicon-based particles (Ps) and the average particle size D of the carbon-based particles (Pc) will be described.

First, SEM (Scanning Electron Microscope) images are observed by the method described in the above-mentioned “Measuring methods of average areas A, B”. In SEM images of the negative electrode active material layers, the carbon-based particles and the silicon-based particles that are in a specific state (that is, a state in which one silicon-based particle (Ps) is surrounded by a plurality of carbon-based particles (Pc) and separated from the carbon-based particles (Pc)) are measured.
Then, 10 carbon-based particles (Pc) whose cross-sections are all exposed are randomly selected to measure the maximum length (the length of the straight line that becomes the longest in the cross-section of the carbon-based particles (Pc)), and the arithmetic mean value of the maximum lengths is defined as the average area A (μm) of the carbon-based particles (Pc).

Similarly, 10 silicon-based particles (Ps) with all exposed cross-sections are randomly selected to measure their respective maximum lengths, and the arithmetic mean value of thee maximum lengths is the average area B (μm) of the silicon-based particles (Ps).

### Components of Negative Electrode for Battery

A negative electrode for a battery according to an embodiment of the present disclosure includes a negative electrode active material layer including silicon-based particles and carbon-based particles as a negative electrode active material.

### Negative Electrode Active Material Layer

Silicon-based particles refer to particles containing silicon (Si), and include particles such as silicon (Si), silicon oxide (SiO), and silicon alloys (SiM, where M represents metallic).

The carbon-based particle means a particle containing carbon (C), and examples thereof include natural graphite, artificial graphite, hard carbon (non-graphitizable carbon), and soft carbon (graphitizable carbon). Examples of artificial graphite include highly oriented graphite and mesocarbon microbeads. The proportion of the graphite in the particle containing carbon (C) is 50% by mass or more, preferably 80% by mass or more.

Other negative electrode active materials may be included, and examples thereof include metals such as metal lithium, metal indium, metal aluminum, metal silicon, and metal tin that can form an alloy with metal lithium or metal lithium, oxides of these metals, and alloys of these metals and metal lithium. Examples of the oxide include an oxide active material such as Li₄Ti₅O₁₂.

The negative electrode active material layer may include a binder in addition to the negative electrode active material. Examples of the binder include rubbers such as styrene-butadiene copolymer (SBR) and vinyl halide resins such as polyvinylidene fluoride (PVdF).

The negative electrode active material layer may further contain other components such as a thickener. Examples of the thickener include celluloses such as carboxymethyl cellulose (CMC).

### Method for Manufacturing Negative Electrode for Battery

A method for manufacturing a negative electrode for a battery according to an embodiment of the present disclosure includes a step of causing a water-insoluble cellulose compound to adhere to surfaces of silicon-based particles, and a step of forming a negative electrode active material layer by mixing the silicon-based particles with the water-insoluble cellulose compound adhering to the surfaces and carbon-based particles.

By causing a water-insoluble cellulose compound to adhere to the surfaces of the silicon-based particles in advance, and mixing the silicon-based particles after the fixing with the carbon-based particles to form a negative electrode active material layer, the negative electrode for a battery according to the embodiment of the present disclosure described above can be manufactured.

This point will be described in detail with reference to FIG. 2. FIG. 2 is a schematic cross-sectional view showing a part of cross-sectional images for describing one step in the manufacturing process of the negative electrode for a battery according to the embodiment of the present disclosure.

In the method for manufacturing a negative electrode for a battery according to the embodiment of the present disclosure, for example, a step of causing a water-insoluble cellulose compound to adhere to the surfaces of the silicon-based particles is performed in advance, and then the silicon-based particles with the water-insoluble cellulose compound adhering to their surfaces and the carbon-based particles are mixed to prepare a slurry, and the slurry is applied and dried to form a negative electrode active material layer. In this way, in the state before drying, as shown in FIG. 2, a water-insoluble cellulose compound 6B adheres to the silicon-based particle (Ps) 2. In addition, the water-insoluble cellulose compound 6B has swellability and is swollen with water. After drying, water in the cellulose compound 6B is also released by drying, and the cellulose compound 6B shrinks like the cellulose compound 6A shown in FIG. 1. This forms a particular state (i.e., a state in which one silicon-based particle (Ps) is surrounded by a plurality of carbon-based particles (Pc) and separated from the carbon-based particles (Pc)), and the ratio B/A is also controlled within the aforementioned ranges.

Examples of the water-insoluble cellulose compound used in the step of causing the water-insoluble cellulose compound to adhere to the surfaces of the silicon-based particles include water-insoluble cellulose compounds such as carboxymethyl cellulose (CMC).

### Battery

Next, each component constituting the battery according to the embodiment of the present disclosure will be described.

### Positive Electrode Active Material Layer

The positive electrode mixture layer includes a positive electrode active material, and may further include, for example, a binder.

Examples of the positive electrode active material include a lithium nickel-cobalt-manganese complex oxide (hereinafter, sometimes simply referred to as “LNCM”). The simplest LNCM is represented by the following general formula: LiNiₓCo_{y}Mn_{z}O₂ (where x, y, and z are 0<x<1, 0<y<1, 0<z<1, x+y+z=1). In addition to Li, Ni, Co, Mn, LNCM may contain other additive elements, such as transition-metal elements other than Ni, Co, Mn, and typical metal elements other than Li. LNCM has a layered crystalline architecture. LNCM may be more than 50% by mass of the entire positive electrode active material, for example, 80 to 100% by mass. The positive electrode active material may be composed only of LNCM.
Examples of other positive electrode active materials include a lithium nickel composite oxide, a lithium cobalt composite oxide, and a lithium nickel manganese composite oxide.

Examples of the binder included in the positive electrode mixture layers include vinyl halide resins such as polyvinylidene fluoride (PVdF).

The positive electrode mixture layer may further contain other components such as a conductive material. Examples of the conductive material include non-graphitizable carbon, graphitizable carbon such as carbon black, and graphite.

### Negative Electrode Active Material Layer

The negative electrode active material layer described above is used as the negative electrode active material layer. Details have already been described, and therefore will be omitted here.

### Positive Electrode Current Collector

The positive electrode active material layer is formed on the positive electrode current collector. As the positive electrode current collector, a conductive member made of a metal having good conductivity (for example, aluminum) is preferable.

### Negative Electrode Current Collector

The negative electrode active material layer is formed on the negative electrode current collector. As the negative electrode current collector, a conductive member made of a metal having good conductivity (for example, copper) is preferable.

### Separator

The separator is an electrically insulating porous film. The separator electrically isolates the positive electrode and the negative electrode. The separator may have a thickness of, for example, 5 μm to 30 μm. The separators may be formed of, for example, a porous polyethylene (PE) membrane, a porous polypropylene (PP) membrane, or the like. The separator may have a multilayer structure. For example, the separators may be formed by laminating a porous PP membrane, a porous PE membrane, and a porous PP membrane in this order. The separator may have a heat resistant layer on its surface. The heat resistant layer includes a heat resistant material. Examples of the heat resistant material include metal oxide particles such as alumina, and high melting point resins such as polyimide.

### Electrolyte

A battery according to an embodiment of the present disclosure further includes an electrolyte. As the electrolyte, either a solid electrolyte or an electrolytic solution can be employed. An electrolyte will be described by taking an electrolyte as an example. In particular, a non-aqueous electrolyte solution is preferable.

### Solvent

The non-aqueous electrolyte solution includes a solvent (non-aqueous solvent) and an electrolyte.

Examples of the solvent (non-aqueous solvent) include N,N-diethyl-N-methyl-N-(2-methoxyethyl) ammonium bis(fluorosulfonyl)imide (DEME), 1-ethyl-3-methylimidazolium bis(fluorosulfonyl)imide (EMI), and 1-ethyl-2,3-dimethylimidazolium bis(fluorosulfonyl)imide (DEMI-FSI).

### Electrolyte

Examples of the electrolyte in the electrolyte solution include Li. Examples of Li salt include lithium bis(fluorosulfonyl)imide (LiFSI), LiPF₆ (lithium hexafluoride phosphate), lithium tetrafluoroborate (LiBF₄), Li[N(CF₃SO₂)₂]).

The amount of electrolyte may be, for example, 1.0 mol/L to 2.0 mol/L, preferably 1.0 mol/L to 1.5 mol/L.

The electrolyte solution may contain, in addition to the solvent and the electrolyte, various additives such as a thickener, a film forming agent, a gas generating agent, and the like. The electrolyte is typically a liquid non-aqueous electrolyte at room temperature (e.g., 25±10° C.). The electrolyte solution typically exhibits a liquid state in the use environment of the battery (for example, in a temperature environment of −20° C. to +60° C.).

### Use

Applications of batteries according to the disclosed embodiments include, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Comparative Example 1

Graphite particles and silicon particles whose ratio D/C between the average particle size D of the graphite particles and the average particle size C of the silicon particles is 1.8 were prepared. The graphite-particles and the silicon-particles, the conductive aid, the carboxymethyl cellulose (CMC), and the styrene-butadiene copolymer (SBR) were mixed at the following solid content ratios to obtain a slurry for forming a negative electrode.

Active material (graphite particles and silicon particles)/conductive aid/CMC/SBR=97/1/1/1 (solid content ratio)

### Example 1

The silicon particles used in Comparative Example 1 and insoluble carboxymethyl cellulose (insoluble CMC) in amounts of 5% by weight based on the silicon particles were dispersed in ethanol, dried using an evaporator, and the insoluble CMC was caused to adhere to the surfaces of the silicon particles to obtain silicon particles 1 having the insoluble CMC adhering to their surfaces.

A slurry for forming a negative electrode was obtained in the same manner as in Comparative Example 1 except that the silicon particles 1 having the insoluble CMC adhering to their surfaces were used instead of the silicon particles in Comparative Example 1. The amount of the insoluble CMC was calculated as the amount of the active material to obtain a slurry for forming a negative electrode at the solid content ratio.

### Example 2

In Example 1, a slurry for forming a negative electrode was obtained in the same manner as in Example 1, except that the amount of the insoluble carboxymethyl cellulose (insoluble CMC) to the silicon particles was set to 7% by mass.

### Example 3

In Example 1, a slurry for forming a negative electrode was obtained in the same manner as in Example 1, except that the amount of insoluble carboxymethyl cellulose (insoluble CMC) to the silicon particles was set to 8% by mass.

### Example 4

In Example 1, a slurry for forming a negative electrode was obtained in the same manner as in Example 1, except that the amount of the insoluble carboxymethyl cellulose (insoluble CMC) to the silicon particles was set to 10% by mass.

### Comparative Example 2

In Example 1, a slurry for forming a negative electrode was obtained in the same manner as in Example 1, except that the amount of the insoluble carboxymethyl cellulose (insoluble CMC) to the silicon particles was set to 12% by mass.

### Comparative Examples 3 to 4 and Examples 5 to 6

As the graphite particles and the silicon particles, a slurry for forming a negative electrode was obtained in the same manner as in Example 2, except that the ratio D/C between the average particle size D of the graphite particles and the average particle size C of the silicon particles was the values shown in Table 1.

### Preparation of Battery

### Positive Electrode

LiNiCoMnO₂(NCM), acetylene black (AB) as a conductive material, and

polyvinylidene fluoride (PVdF) as a binder were mixed in the following ratios to obtain a slurry for forming a positive electrode.

NCM/AB/PVdF=92/5/3(ms%)

The slurry for forming a positive electrode was applied to a positive electrode collector foil (A1 foil, thickness: 15 micrometers) and pressed to a predetermined thickness to form a positive electrode.

### Negative Electrode

The negative electrode forming slurries obtained in Examples and Comparative Examples were applied to a negative electrode collector foil (Cu foil, 10 μm thick), dried, and pressed to a predetermined thickness to form a negative electrode.

### Battery

The positive electrode and the negative electrode were wound with a separator interposed therebetween to form an electrode group. The separator used was a porous polypropylene (PP)/porous polyethylene (PE)/PP three-layer structure (thickness: 24 μm) and coated with ceramics (alumina) (4 μm) on the positive electrode side.

Next, a current collector plate with a lid was welded to both ends of the electrode group, inserted into the case, and the lid plate and the case were welded. Further, an electrolyte solution was injected from the injection hole at a predetermined amount, and a sealing screw was tightened to the injection hole. As the electrolyte solution, an electrolyte solution containing ethylene carbonate (EC), dimethyl carbonate (DMC), and ethyl methyl carbonate (EMC) in a EC: DMC: EMC ratio of 3:3:4 (volume ratio) was used as the electrolyte solution, and LiPF₆1M (mol/l was used as the electrolyte solution. After the injection, the electrolyte solution was impregnated with the electrolyte solution at a fixed time, and then, after charging, the battery was aged at 60° C. to obtain a battery.

The ratio (area ratio) B/A and the ratio (particle diameter ratio) D/C were determined for the batteries obtained in the respective Examples and Comparative Examples by the above-described methods. The results are shown in Table 1.

### Evaluation: Cycle Characteristics

For the batteries obtained in the Examples and Comparative Examples, the rated capacity was measured before and after the cycle under the following test conditions. The ratio of the rated capacity after the cycle to the rated capacity before the cycle (capacity retention ratio (%)) is shown in Table 1. The higher the capacity retention ratio, the better the performance of the cell. The test conditions were: at 60° C., 2C rate was 300 cycle between SOC0% and 100%, and charging/discharging was performed.

TABLES 1

| | | Particle | |
|---|---|---|---|
| | Area | Size | Cycle |
| | Ratio | Ratio | Characteristics |
| | (B/A) | (D/C) | [%] |
| Comparative | 1.01 | 1.8 | 73 |
| Example 1 | | | |
| Example 1 | 1.06 | 1.8 | 76 |
| Example 2 | 1.30 | 1.8 | 81 |
| Comparative | 1.30 | 1.3 | 73 |
| Example 3 | | | |
| Example 5 | 1.30 | 1.5 | 78 |
| Example 2 | 1.30 | 1.8 | 81 |
| Example 3 | 2.40 | 1.8 | 82 |
| Example 4 | 3.10 | 1.8 | 78 |
| Comparative | 3.40 | 1.8 | 72 |
| Example 2 | | | |
| Example 6 | 1.30 | 2.8 | 75 |
| Comparative | 1.30 | 3.0 | 71 |
| Example 4 | | | |

The results in Tables 1 show that the examples in which the ratio (area ratio) B/A is 1.05 or more and 3.10 or less and the ratio (particle-size ratio) D/C is 1.5 or more and 2.8 or less have better cycle characteristics than Comparative Examples 1 and 2 in which the ratio (area ratio) B/A is outside the above range and Comparative Examples 3 and 4 in which the ratio (particle size ratio) D/C is outside the above range.

What is claimed is:

1. A negative electrode for a battery, the negative electrode comprising a negative electrode active material layer containing silicon-based particles and carbon-based particles, wherein
when a cross-sectional image of the negative electrode active material layer is observed, the negative electrode active material layer contains one silicon-based particle Ps surrounded by a plurality of carbon-based particles Pc and separated from the carbon-based particles Pc,
in the cross-sectional image, a ratio B/A is 1.05 or more and 3.10 or less, where A is an average area of the silicon-based particle Ps, and B is an average area of an ellipse or a perfect circle that is drawn in a region where the silicon-based particle Ps is separated from the carbon-based particles Pc, the ellipse or the perfect circle having a maximum area, containing the silicon-based particle Ps, and not overlapping contours of the carbon-based particles Pc, and
a ratio D/C is 1.5 or more and 2.8 or less, where C is an average particle size of the silicon-based particle Ps, and D is an average particle size of the carbon-based particles Pc.

2. The negative electrode according to claim 1, wherein the ratio B/A is 1.30 or more and 2.40 or less.

3. The negative electrode according to claim 1, wherein a water-insoluble cellulose compound is contained in the region where the silicon-based particle Ps is separated from the carbon-based particles Pc.

4. A battery comprising the negative electrode according to claim 1.

5. A method for manufacturing a negative electrode for a battery, the method comprising the steps of:
causing a water-insoluble cellulose compound to adhere to surfaces of silicon-based particles; and
forming a negative electrode active material layer by mixing the silicon-based particles with the water-insoluble cellulose compound adhering to the surfaces and carbon-based particles.
